(19) United States
(12) Patent Application Publication
(10) Pub. No.: US 2012/0099005 A1
(43) Pub. Date: Apr. 26, 2012

(54) METHODS AND SYSTEMS FOR READING AN IMAGE SENSOR BASED ON A TRAJECTORY

(76) Inventors: Eran Kali, Tel-Aviv (IL); Yariv Oz, Tel Aviv (IL); Pichas Dahan, Tel-Aviv (IL); Shahar Kovalsky, Tel-Aviv (IL); Oded Gigushinski, Tel-Aviv (IL); Noy Cohen, Tel-Aviv (IL); Ephraim Goldenberg, Tel-Aviv (IL)

(21) Appl. No.: 13/264,251

(22) PCT Filed: Apr. 9, 2010
(86) PCT No.: PCT/EP2010/054734

§ 371 Date: Jan. 6, 2012

Related U.S. Application Data
(60) Provisional application No. 61/168,705, filed on Apr. 13, 2009.

(51) Int. Cl. H04N 5/262; H04N 5/228

(52) U.S. Cl. 348/240.99; 348/222.1; 348/E05.031; 348/E05.055

(57) ABSTRACT

An optical system can provides a distorted image of an object within a field of view onto sensing pixels of an image capturing device. The optical system can expand the image in a center of the field of view and compress the image in a periphery or introduce other distortion. The distortion intentionally introduced by the optical system is corrected when the sensing pixels are read to remove some or all of the distortion and thereby produce a “rectified” image. The pixels can be read along a trajectory corresponding to a curvature map of the distorted image to rectify distortions during pixel read out, rather than waiting until all or substantially all of the sensing pixels have been read. Sensor logic and/or algorithms can be used in removing the distortion.

### RELATED APPLICATION DATA

The present application claims priority to U.S. Provisional Patent Application Ser. No. 61/168,705, filed Apr. 13, 2009 which is hereby incorporated by reference in its entirety.

### BACKGROUND

Recently, image capturing devices have become widely used in portable and non-portable devices such as cameras, mobile phones, webcams and notebooks. These image capturing devices conventionally include an electronic image detector such as a CCD or CMOS sensor, a lens system for projecting an object in a field of view (FOV) onto the detector and electronic circuitry for receiving, processing, and storing electronic data provided by the detector. The sensing pixels are typically read in raster order, i.e., left-to-right in rows from top to bottom. Resolution and optical zoom are two important performance parameters of such image capturing devices.

Resolution of an image capturing device is the minimum distance two point sources in an object plane can have such that the image capturing device is able to distinguish these point sources. Resolution depends on the fact that, due to diffraction and aberrations, each optical system projects a point source not as a point but a disc of predetermined width and having a certain light intensity distribution. The response of an optical system to a point light source is known as point spread function (PSF). The overall resolution of an image capturing device mainly depends on the smaller one of the optical resolution of the optical projection system and the resolution of the detector.

Herein, the optical resolution of an optical projection system shall be defined as the full width at half maximum (FWHM) of its PSF. In other words, the peak values of the light intensity distribution of a projection of two point light sources must be spaced at least by the FWHM of the PSF in order for the image capturing device to be able to distinguish the two point light sources. However, the resolution could also be defined as a different value depending on the PSF, e.g. 70% of the width at half maximum. This definition of the optical resolution might depend on the sensitivity of the detector and the evaluation of the signals received from the detector.

The resolution of the detector is defined herein as the pitch, i.e., distance middle to middle of two adjacent sensor pixels of the detector.

Optical zoom signifies the capability of the image capturing device to capture a part of the FOV of an original image with better resolution compared with a non-zoomed image. Herein, it is assumed that in conventional image capturing devices the overall resolution is usually limited by the resolution of the detector, i.e. that the FWHM of the PSF can be smaller than the distance between two neighboring sensor pixels.

Accordingly, the resolution of the image capturing device may be increased by selecting a partial field of view and increasing the magnification of the optical projection system for this partial field of view. For example, ×2 optical zoom refers to a situation where all sensor pixels of the image detector capture half of the image, in each dimension, compared with that of ×1 zoom.

As used herein, “digital zoom” refers to signal interpolation where no additional information is actually provided, whereas “optical zoom” refers to magnification of the projected partial image, providing more information and better resolution. For example, multi-use devices having incorporated cameras (e.g., mobile phones, web cameras, portable computers) use fixed zoom. Digital zoom is provided by cropping the image down to a smaller size and interpolating the cropped image to emulate the effect of a longer focal length. Alternatively, adjustable optics may be used to achieve optical zoom, but this can add cost and complexity to the camera.

### SUMMARY

Embodiments configured in accordance with one or more aspects of the present subject matter can overcome one or more of the problems noted above through the use of an optical system that provides a distorted image of an object within a field of view onto sensing pixels of an image capturing device. The optical system can expand the image in a center of the field of view and compress the image in a periphery.

The distortion intentionally introduced by the optical system is corrected when the sensing pixels are read to remove some or all of the distortion and thereby produce a “rectified” image. The pixels can be read along a trajectory corresponding to a curvature map of the distorted image to rectify distortions during pixel read out, rather than waiting until all or substantially all of the sensing pixels have been read.

A method of imaging can comprise imaging a distorted image of a field of view onto an array of sensor pixels, reading the sensor pixels according to the distortion of the image, and generating an output image based on the read pixels. The output image can be substantially or completely free of the distortion, with “substantially free” meaning that any residual distortion is within acceptable tolerance values for image quality in the particular use of the image.

Reading the sensor pixels according to the distortion of the image can comprise using logic of a sensor to sample pixel values along a plurality of trajectory lines corresponding to the distortion and providing a plurality of logical output rows in a virtual/logical readout image. Each logical output row can comprise a single pixel value corresponding to each column of the sensor array.

At least two trajectory lines can intersect the same pixel, and the logic of the sensor can be configured to provide a dummy pixel value during readout for one of the logical output rows in place of a value for the pixel that is intersected twice, with the logic of the sensor further configured to replace the dummy pixel value with the value of a non-dummy pixel at the same column address and lying in another logical row. This can ensure that the virtual/logical readout image features the same number of columns as the physical sensor array. The number of rows in the virtual/logical readout image may differ, however. For example, in some embodiments the read logic is configured so that additional trajectory curves, each with a corresponding logical readout row, are used so that no pixels of the physical sensor array are left unsampled.

In additional embodiments, reading the pixels according to the distortion function can comprise using a processor to access pixel values sampled according to rows and columns, the processor configured to access the pixel values by using a mapping of output image pixel coordinates to sensor pixel coordinates. However, this approach may in some cases require more buffer memory than other embodiments discussed herein.

Embodiments include a method of reading pixels of an image sensor, the pixels capturing data representing a distorted image, in a pixel order based on a known distortion function correlating the distorted image sensed by the pixels of the image sensor to a desired rectified image. For example, a pixel mapping function may be provided as a table accessible during pixel reading that provides a sensor pixel address as a function of a rectified image pixel address. As another example, a function may be evaluated to provide a sensor pixel address in response to an input comprising a rectified image pixel address. As a further example, sensor hardware may be configured to read pixels along trajectories corresponding to the distortion function, rather than using conventional row and column addressing.

Embodiments of a method of reading pixels can comprise receiving a read command specifying a first pixel address of a rectified image. The method can further comprise determining one or more trajectories of pixels of a sensor to access. The trajectory or trajectories may be determined from a mapping of a distorted image to the rectified image. Data from the accessed pixels on the trajectory (or trajectories) can be stored in memory and the pixels in the row corresponding to the specified first pixel address of the rectified image can be determined from the accessed pixels.

In some embodiments, the value of pixels in a given row in the rectified image may depend on pixels from multiple rows (e.g., neighboring pixels), and so in some embodiments, a first plurality of and second plurality of pixels are determined based on the mapping and accessed accordingly. The first and second pluralities of pixels in a row of the rectified image may be determined by accessing pixels from some, but not all, of the same rows of sensed pixels (i.e., at least one group has a row not included in the other group) or may be completely different (i.e., no rows in common).

Embodiments include a sensing device configured to receive a read command specifying at least one pixel address and determine a corresponding pixel address identifying one or more rows to read from an array of pixels based on a distortion function. The pixel address may be associated with a zoom factor, and one of a plurality of distortion functions, each corresponding to a zoom factor, may be selected for use in determining which pixel address to read. In various embodiments, the sensing device may be provided alone and/or may be incorporated into a portable computer, a cellular telephone, a digital camera, or another device.

The sensing device may be configured to support trajectory-based access of pixels. For example, the clock lines that grant read-out authorization and the clock lines that control reading of information from actual pixels can be configured so that the sensor is read along several arcs corresponding to the curvature introduced by the distortion optics, rather than by rows and columns, with each arc loaded into a buffer at reading. The methods noted above can be used to make slight adjustments in the reading trajectory to make corrections, such as for slight aberrations in the lens.

### BRIEF DESCRIPTION OF THE DRAWINGS

The above and other features and advantages will become readily apparent to those of skill in the art by describing in detail example embodiments with reference to the attached drawings, in which:

FIGS. 1A and 1B illustrate a rectangular pattern and a distorted rectangular pattern having distortion that is separable in X & Y coordinates, respectively;

FIGS. 2A and 2B illustrate an example of a circularly symmetric pattern and a distorted circularly symmetric pattern, respectively;

FIGS. 3A to 3D illustrate an object and corresponding displayed images for different zoom levels in accordance with an embodiment;

FIG. 4A illustrates an example of an optical design in accordance with an embodiment;

FIG. 4B-1 illustrates grid distortions produced using the optical design of FIG. 4A;

FIG. 4B-2 illustrates renormalized grid distortions produced using the optical design of FIG. 4A;

FIG. 4C illustrates field curvature of the optical design of FIG. 4A;

FIG. 4D illustrates distortion of the optical design of FIG. 4A;

FIG. 4E illustrates an example of a processing architecture for obtaining sensor data;

FIG. 4F illustrates another example of a processing architecture for obtaining sensor data;

FIG. 5 illustrates a flowchart of an operation of the image processor of FIG. 4A in accordance with an embodiment;

FIG. 6 illustrates an exploded view of a digital camera in accordance with an embodiment;

FIG. 7A illustrates a perspective view of a portable computer with a digital camera integrated therein in accordance with an embodiment;

FIG. 7B illustrates a front and side view of a mobile telephone with a digital camera integrated therein in accordance with an embodiment;

FIG. 8 illustrates an example of a process for reading pixels along a trajectory;

FIG. 9 illustrates an example of an array of pixels and several trajectories;

FIG. 10 illustrates an example of an array of pixels in a sensor configured for trajectory-based access; and

FIG. 11 illustrates an example of a function mapping pixels of a rectified and distorted image.

FIG. 12 shows an example of how output pixels can be mapped to sensor pixels using a nearest-neighbor integer mapping.

FIG. 13 shows an example of horizontal lines distorted by a lens of an optical system, including an indication of maximal distortion.

FIG. 14 is a chart showing the number line buffers required to read a single output row directly according to a function relating output image coordinates to sensor coordinates due to vertical distortion.

FIG. 15 is a diagram illustrating an example of a multi-step readout process that uses logic to sample pixel values and produce a distorted virtual/logical readout image along with an algorithm relating output image coordinates to coordinates in the virtual/logical readout image.

FIG. 16 is a diagram shown relationships between output pixel values, virtual/logical sensor pixel values, and physical sensor pixel values.

FIG. 17 shows an example of a sensor configuration where each virtual/logical row comprises one pixel from each physical sensor column.

FIG. 18 illustrates an example of how a physical sensor pixel can be associated with a virtual/logical sensor pixel based on a trajectory.

FIG. 19 illustrates how, in some embodiments, trajectory density can vary across a distorted image.

FIGS. 20A-20B illustrate how, in some embodiments, additional trajectories can be used to avoid the problem of skipped pixels due to trajectory density.

FIGS. 21A-21D illustrate how dummy pixels can be used to avoid reading a physical sensor pixel twice due to intersection with multiple curves.

FIG. 22 illustrates relationships between output pixels, virtual/logical sensor pixels, and physical sensor pixels for use by an algorithm used to map output image pixel addresses to pixel addresses in a logical/virtual readout image.

### DETAILED DESCRIPTION

Embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the embodiments to those skilled in the art. In the figures, the dimensions of layers and regions are exaggerated for clarity of illustration. Like reference numerals refer to like elements throughout.

In accordance with embodiments, an optical zoom may be realized using a fixed-zoom lens combined with post processing for distortion correction. A number of pixels used in the detector may be increased beyond a nominal resolution desired to support zoom capability. First, an initial introduction to the concept of using distortion to realize zoom will be briefly discussed.

Commonly assigned, co-pending PCT Application Serial No. EP2006-002864, which is hereby incorporated by reference, discloses an image capturing device including an electronic image detector having a detecting surface, an optical projection system for projecting an object within a field of view (FOV) onto the detecting surface, and a computing unit for manipulating electronic information obtained from the image detector. The projection system projects and distorts the object such that, when compared with a standard lens system, the projected image is expanded in a center region of the FOV and is compressed in a border region of the FOV.

For additional discussion, see U.S. patent application Ser. Nos. 12/225,591, filed Sep. 25, 2008 (the US national phase of the PCT case PCT/EP2006/002861, filed Mar. 29, 2006) and 12/213,472 filed Jun. 19, 2008 (the national phase of PCT/IB2007/004278, filed Sep. 14, 2007), each of which is incorporated by reference herein in its entirety.

As disclosed therein, the projection system may be adapted such that its point spread function (PSF) in the border region of the FOV has a FWHM corresponding essentially to the size of corresponding pixels of the image detector. In other words, this projection system may exploit the fact that resolution in the center of the FOV is better than at wide incident angles, i.e., the periphery of the FOV. This is due to the fact that the lens's point spread function (PSF) is broader in the FOV borders compared to the FOV center.

The resolution difference between the on-axis and peripheral FOV may be between about 30% and 50%. This effectively limits the observable resolution in the image borders, as compared to the image center.

Thus, the projection system may include fixed-zoom optics having a larger magnification factor in the center of the FOV compared to the borders of the FOV. In other words, an effective focal length (EFL) of the lens is a function of incident angle such that the EFL is longer in the image center and shorter in the image borders. Such a projection system projects a distorted image, in which the central part is expanded and the borders are compressed. Since the magnification factor in the image borders is smaller, the PSF in the image borders will become smaller too, spreading on fewer pixels on the sensor, e.g., one pixel instead of a square of four pixels. Thus, there is no over-sampling these regions, and there may be no loss of information when the PSF is smaller than the size of a pixel. In the center of the FOV, however, the magnification factor is large, which may result in better resolution. Two discernable points that would become non-discernable on the sensor due to having a PSF larger than the pixel size may be magnified to become discernable on the sensor, since each point may be captured by a different pixel.

The computing unit may be adapted to crop and compute a zoomed, undistorted partial image (referred to as a “rectified image” or “output image” herein) from the center region of the projected image, taking advantage of the fact that the projected image acquired by the detector has a higher resolution at its center than at its border region. However, as will be discussed below, in presently-disclosed embodiments, some or all of the computation of the rectified image can be handled during the process of reading sensing pixels of the detector.

For normal pictures of the entire field of view, the center region can be compressed computationally. However, if a zoomed image near the center is to be taken, this can be done by simply cropping the desired area near the center and compressing it less or not compressing it at all, depending on the desired zoom and the degree of distortion of the portion of the image that is to be zoomed. In other words, with respect to a non-zoomed image, the image is expanded and cropped so that a greater number of pixels may be used to describe the zoomed image. This may be achieved by reading the pixels of the detector along a trajectory that varies according to the desired zoom level.

Thus, this zoom matches the definition of optical zoom noted above. However, this optical zoom may be practically limited to about ×2 or ×3.

In order to realize larger zoom magnifications, embodiments are directed to exploiting the tradeoff between the number of pixels used and the zoom magnification. In other words, larger zoom magnifications may require increasing the number of pixels in the sensor to avoid information loss at the borders. A number of pixels required to support continuous zoom may be determined from discrete magnifications, where Z₁ is the largest magnification factor and Z_{P} is the smallest magnification factor. The number of pixels required to support these discrete zoom modes, considering N pixels to cover the whole FOV may be given by Equation 1:

$$\tilde{N} = N + N ( 1 - {( \frac{{Z}_{2}}{{Z}_{1}} )}^{2} ) + N ( 1 - {( \frac{{Z}_{3}}{{Z}_{2}} )}^{2} ) + … + N ( 1 - {( \frac{{Z}_{P}}{{Z}_{P - 1}} )}^{2} ) \qquad ( 1 )$$

Rearranging Equation 1, Equation 2 may be obtained as follows:

$$\frac{\tilde{N}}{N} = P - {\sum }_{i = 1}^{P - 1} {( \frac{{Z}_{i + 1}}{{Z}_{i}} )}^{2} \qquad ( 2 )$$

Substituting Z₁-ΔZ for Zᵢ₊₁ in order to obtain a continuous function of Z results in Equation 3:

$$\frac{\tilde{N}}{N} = P - {\sum }_{i = 1}^{P - 1} ( 1 - \frac{2 Δ Z}{{Z}_{i}} + {( \frac{Δ Z}{{Z}_{i}} )}^{2} ) \qquad ( 3 )$$

Discarding higher power terms, e.g., above the first term, and replacing summation with integration, Equation (4) may be obtained:

$$\frac{\tilde{N}}{N} = P - ( ( P - 1 ) - 2 {\int }_{{Z}_{min} = 1}^{\hat{Z}} \frac{d Z}{Z} ) = 2 ln ( \hat{Z} ) + 1 \qquad ( 4 )$$

where \hat{Z} is the maximal zoom magnification desired.

In other words, for a standard digital camera, i.e., distortion free, with a rectangular sensor of K Mega Pixels ([MP]) producing an image of L[MP](L<K), the maximum applicable optical zoom (for L[MP] image) for the entire image may be limited to

$$\sqrt{\frac{K}{L}} .$$

In other words, for a desired optical zoom, Z, K equals Z² times L.

Thus, when the zoom required is ×2, a standard camera requires four times more pixels. However, in accordance with embodiments, higher zoom may be realized at the center of the image due to the distorting mechanism the optics introduces. Thus, as can be seen from Equation 4 above, only approximately 2.38 times as many pixels may be needed for an ×2 zoom. For example, using a standard 2 MP image sensor, applying 2× zoom will require 4.77 MP for a completely lossless zoom. Relaxing demands on the quality in image borders, i.e., allowing loss of information, will decrease this number, e.g., down to about 1.75 times as many pixels for ×2 zoom.

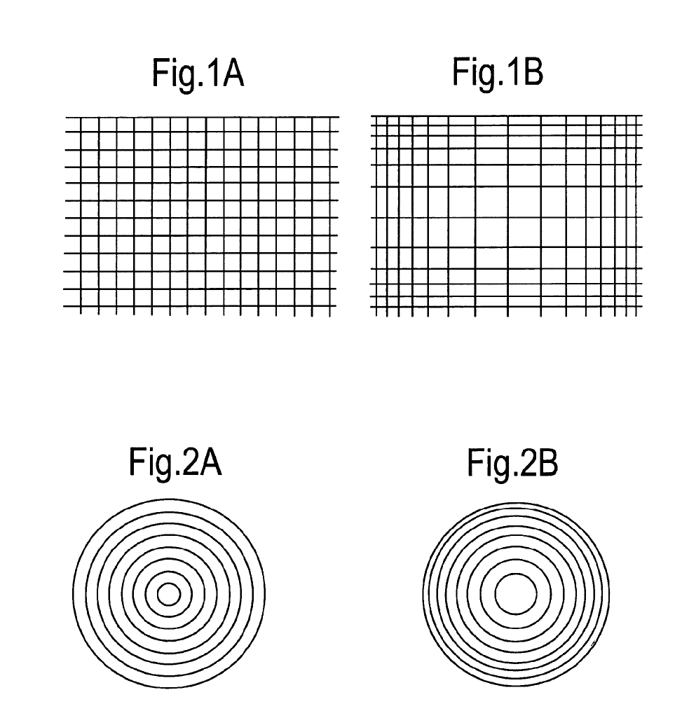

FIGS. 1A and 1B illustrate an original rectangular pattern and a projected rectangular pattern as distorted in accordance with an embodiment, respectively. In this specific example, the transformation representing the distortion is separable in the horizontal and vertical axes. FIGS. 2A and 2B illustrate an original circularly symmetric pattern and a projected circularly symmetric pattern as distorted in accordance with an embodiment, respectively. As can be seen therein, the patterns are expanded in a central region and compressed in a border region. Other types of distortion, e.g., anamorphic distortion, may also be used.

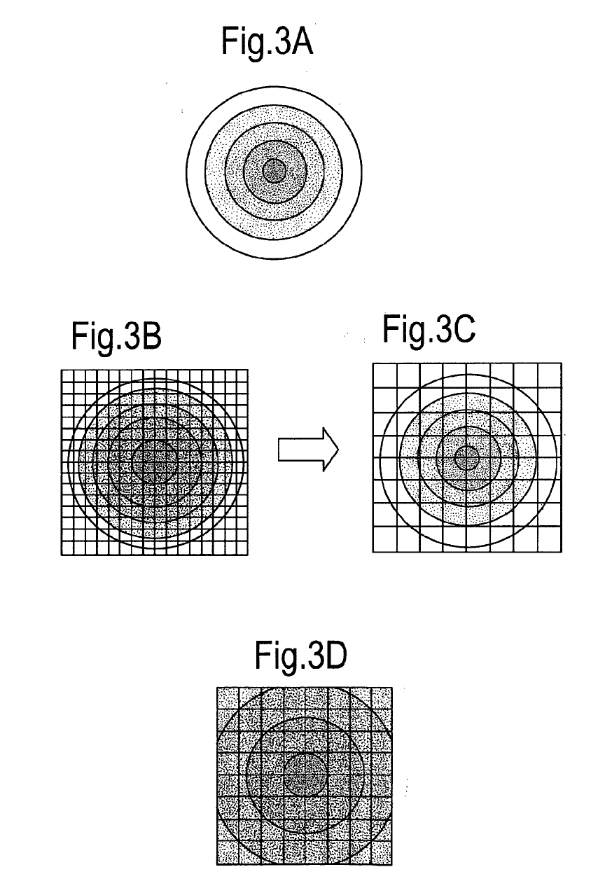

FIGS. 3A to 3D illustrate a general process of imaging an object, shown in FIG. 3A, in accordance with embodiments. The object is first projected and distorted by a lens system in accordance with an embodiment and captured by a high resolution, i.e., K[MP] detector, in FIG. 3B. A corrected lower resolution, i.e., L[MP] image with a ×1 zoom is illustrated in FIG. 3C. A corrected ×2 zoom image, having the same L[MP] resolution as the ×1 image, is shown in FIG. 3D.

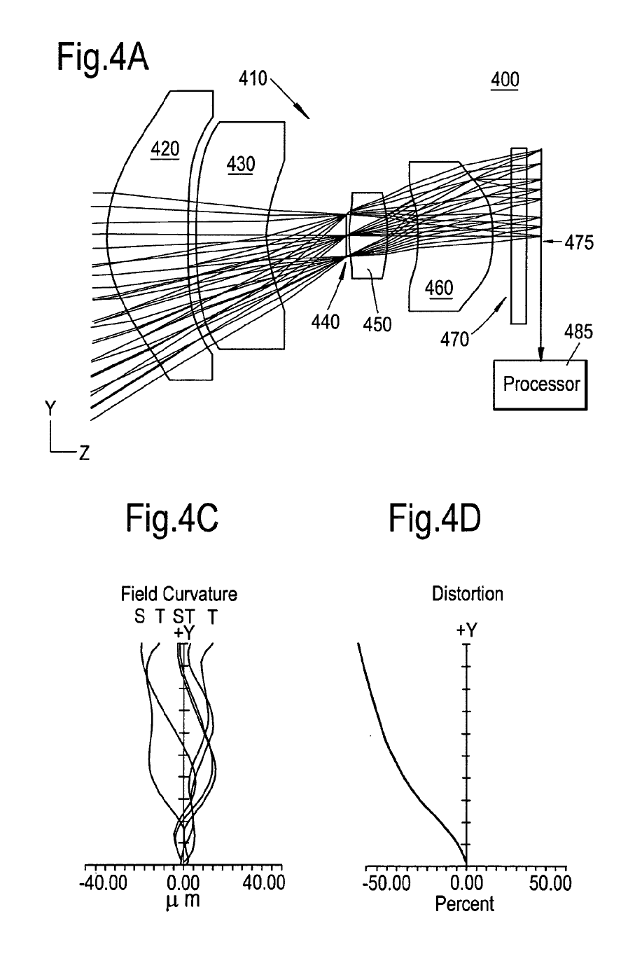

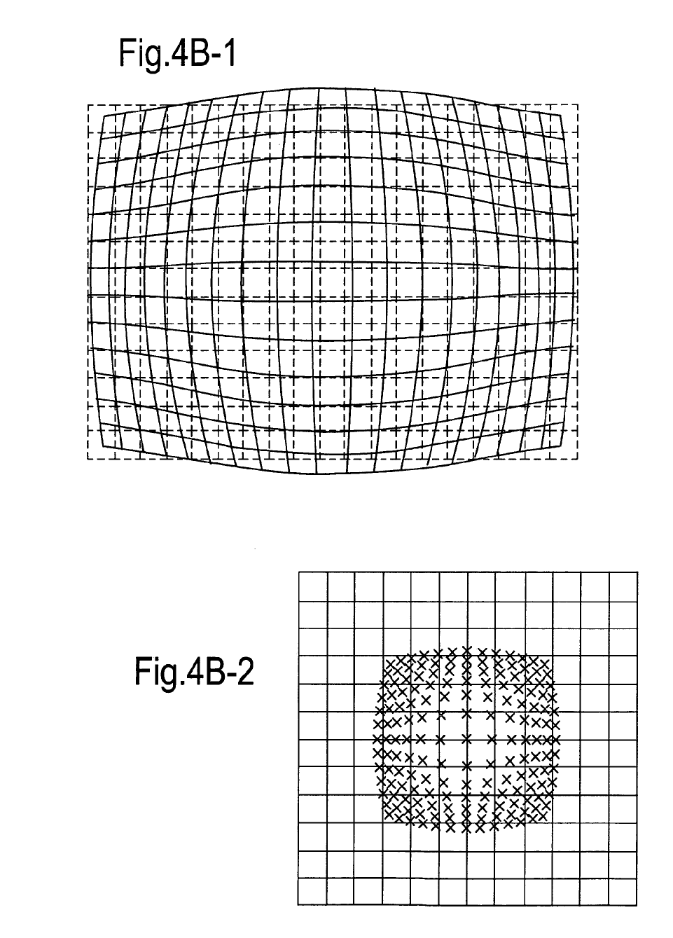

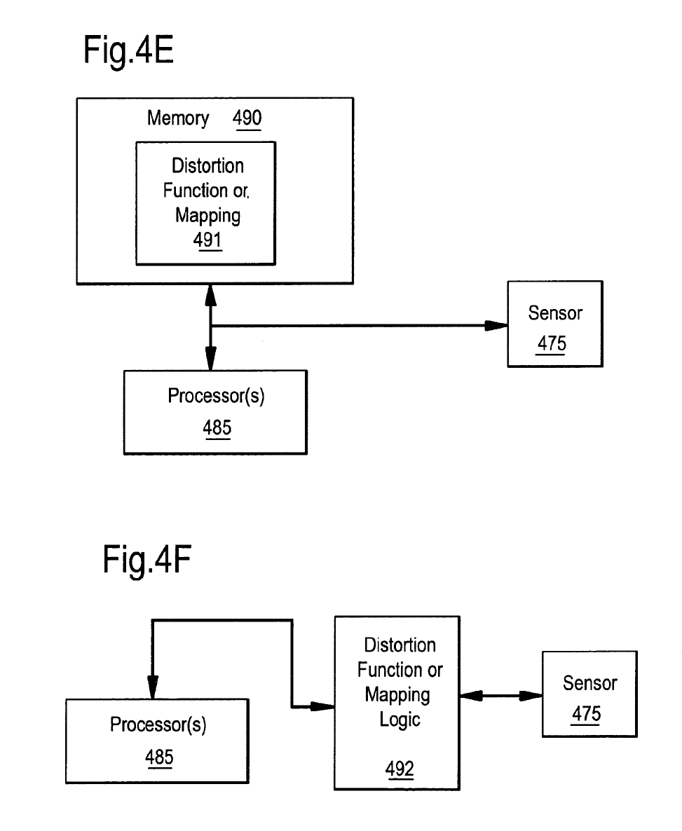

FIG. 4A illustrates an example imaging capturing device 400 including an optical system 410 for imaging an object (not shown) onto a detector 475, i.e., an image plane, that outputs electrical signals in response to the light projected thereon. These electrical signals may be supplied to a processor 485, which may process, store, and/or display the image. As noted below, the electrical signals are accessed in a manner so that the pixels of the detector are read along a trajectory corresponding to the distortion of the image and the desired magnification level.

The optical system 410 may include a first lens 420 having second and third surfaces, a second lens 430 having fourth and fifth surfaces, an aperture stop 440 at a sixth surface, a third lens 450 having seventh and eight surfaces, a fourth lens 460 having ninth and tenth surfaces, an infrared (IR) filter 470 having eleventh and twelfth surfaces, all of which image the object onto the image plane 475.

In this particular example, the optical system 410 may have a focal length of 6 mm and an F-number of 3.4. The optical system 410 according to an embodiment may provide radial distortion having image expansion in the center and image compression at the borders for a standard FOV of ±30°.

The optical design coefficients and the apertures of all optical surfaces along with the materials from which the lenses may be made are provided as follows:

TABLE 1

| | | Radius | Thick | | Semi- | | Parameter | Parameter | Parameter | Parameter | Parameter |
|---|---|---|---|---|---|---|---|---|---|---|---|
| # | Note | (mm) | (mm) | Medium | Diameter | Conic | X2 | X4 | X6 | X8 | X10 |
| 0 | OBJ | Infinite | Infinite | Air | 653.2 | 0.000 | 0.000 | 0.000 | 0.000 | 0.000 | 0.000 |
| 1 | | Infinite | 0.30 | Air | 4.0 | −0.932 | 0.000 | 0.000 | 0.000 | 0.000 | 0.000 |
| 2 | L1 | 2.900 | 1.68 | Plastic | 3.0 | −100.00 | 0.000 | 0.017 | −0.001 | 0.000 | 0.000 |
| 3 | | 1000 | 0.17 | Plastic | 2.5 | −100.00 | 0.000 | 0.022 | −0.001 | 0.000 | 0.000 |
| 4 | L2 | 112.00 | 1.47 | Plastic | 2.4 | 0.455 | 0.000 | −0.027 | −0.001 | 0.000 | 0.000 |
| 5 | | 2.700 | 1.68 | Plastic | 1.6 | 0.000 | 0.000 | 0.000 | 0.000 | 0.000 | 0.000 |
| 6 | APS | Infinite | 0.05 | Air | 0.4 | 12.800 | 0.000 | −0.067 | −0.049 | 0.000 | 0.000 |
| 7 | L3 | 3.266 | 0.80 | Plastic | 0.6 | 8.000 | 0.000 | 0.066 | 0.044 | 0.000 | 0.000 |
| 8 | | −3.045 | 0.63 | Plastic | 0.9 | 2.979 | 0.000 | 0.000 | 0.075 | 0.000 | 0.000 |
| 9 | L4 | −2.504 | 1.51 | Plastic | 1.1 | 22.188 | 0.000 | −0.312 | 0.175 | −0.055 | 0.010 |
| 10 | | −7.552 | 0.39 | Plastic | 1.6 | 0.000 | 0.000 | 0.000 | 0.000 | 0.000 | 0.000 |
| 11 | IRF | Infinite | 0.30 | N-BK7 | 1.8 | 0.000 | 0.000 | 0.000 | 0.000 | 0.000 | 0.000 |
| 12 | | Infinite | 0.23 | Air | 1.9 | 0.000 | 0.000 | 0.000 | 0.000 | 0.000 | 0.000 |
| 13 | IMG | Infinite | 0.00 | | 1.8 | 0.000 | 0.000 | 0.000 | 0.000 | 0.000 | 0.000 |

Here, surface 0 corresponds to the object, L1 corresponds to the first lens 420, L2 corresponds to the second lens 430, APS corresponds to the aperture stop 440, L3 corresponds to the third lens 450, L4 corresponds to the fourth lens 460, IRF corresponds to the IR filter 460 and IMG corresponds to the detector 475. Of course, other configurations realizing sufficient distortion may be used.

Plastic used to create the lenses may be any appropriate plastic, e.g., polycarbonates, such as E48R produced by Zeon Chemical Company, acrylic, PMMA, etc. While all of the lens materials in Table 1 are indicated as plastic, other suitable materials, e.g., glasses, may be used. Additionally, each lens may be made of different materials in accordance with a desired performance thereof. The lenses may be made in accordance with any appropriate method for the selected material, e.g., injection molding, glass molding, replication, wafer level manufacturing, etc. Further, the IR filter 470 may be made of suitable IR filtering materials other than N-BK7.

FIG. 4B-1 illustrates how a grid of straight lines (indicated with dashed lines) is distorted (indicated by the curved, solid lines) by the optical system 410. The magnitudes of the distorted lines depend on the distance from the optical axis. Near the center of the image the grid is expended, while the grid in the periphery is shrinking.

FIG. 4B-2 illustrates the renormalized (to the center) lens distortion that shows how a grid of straight lines is distorted by the optical system 410. The distorted lines are represented by the cross marks on the figure, which displays an increasing distortion with the distance from the optical axis.

FIG. 4C illustrates field curvature of the optical system 410. FIG. 4D illustrates distortion of the optical system 410.

FIG. 4E illustrates an example of an architecture that may be used to facilitate accessing pixels along a trajectory. In this example, processor 485 has access to volatile or nonvolatile memory 490 which may embody code and/or data 491 representing a distortion function or mapping of rectified image pixels to sensing pixels. Processor 485 can use the code and/or data 491 to determine which addresses and other commands to provide to sensor 475 so that pixels are accessed along a trajectory.

FIG. 4F illustrates an example of another architecture that may be used to facilitate accessing pixels along a trajectory. In this example, sensor 475 includes or is used alongside read logic 492 that implements the distortion function or mapping. Thus, processor 485 can request values for one or more pixels in the rectified image directly, with the task of translating the rectified image addresses to sensing pixel addresses handled by sensor 475. Logic 492 may, of course, be implemented using another processor (e.g., microcontroller).

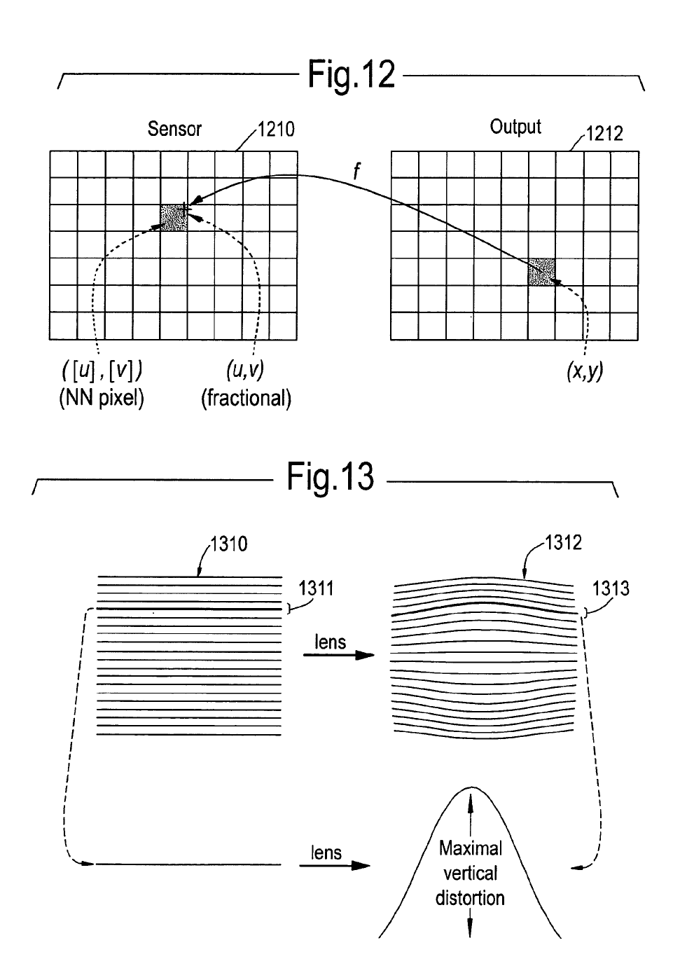

Additional embodiments of sensor logic are discussed later below in conjunction with FIGS. 12-22. For instance, in some embodiments the read logic is configured to read pixels of the sensor along trajectories according to the distortion and to provide a virtual/logical readout image for access by the processor. For example, the pixels may be read so that the virtual/logical readout image is completely or substantially free of vertical distortion. The processor can then use a function mapping output image addresses to addresses in the virtual/logical readout image to generate the output image.

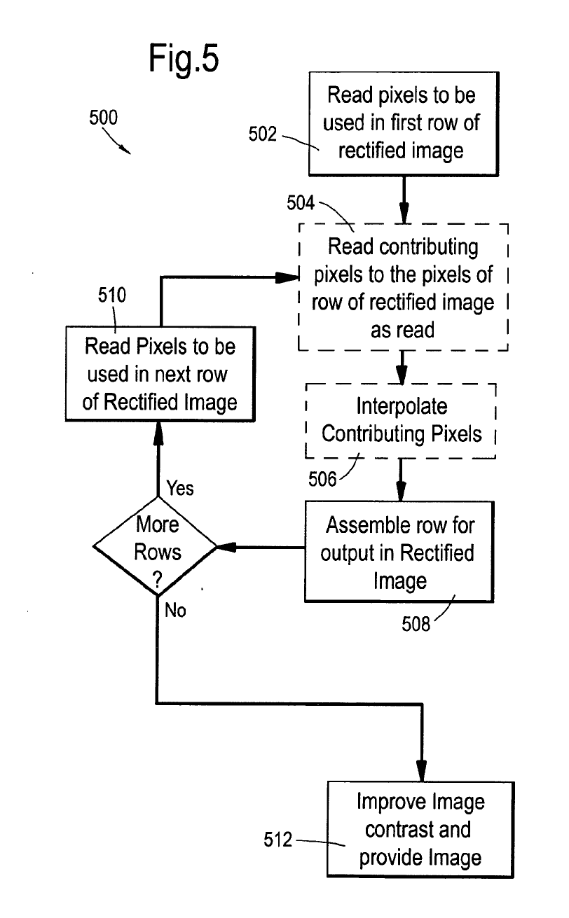

FIG. 5 illustrates a flowchart of an operation 500 that may be performed by the processor 485 and/or sensor 475 while accessing pixels. For example, processor 485 may include an image signal processing (ISP) chain that receives an image or portions thereof from the sensor 475. At block 502, the pixels to be used in the first row of the rectified image are read. In some embodiments, pixels from a given row depend on pixels from a plurality of rows (e.g., a pixel whose value depends on one or more vertical neighbors). Thus, blocks 504 and 506 are included to represent reading “contributing” pixels and interpolating those pixels. For instance, as noted below, the sensor may be read along a series of arcs. Each arc may include multiple pixels, or pixels from a number of arcs may be interpolated to identify pixels of a given row.

At block 508, the row is assembled for output in a rectified image. If more rows are to be assembled into the rectified image, then at block 510 the pixels to be used in the next row of the rectified image are read, along with contributing rows, and interpolation is performed to assemble the next row for output.

Once all desired rows of the rectified image have been obtained, then at 512 the image can be improved for output, such as adjusting its contrast, and then output for other purposes such as JPEG compression or GIF compression. Although this example includes a contrast adjustment, the raw image after interpolation could simply be provided for contrast and other adjustment by another process or component.

Pixel interpolation may be performed since there might not be a pixel-to-pixel matching between the distorted image and the rectified image even when pixels are read along a trajectory based on the distortion. Thus, both 1× magnification, in which the center of the image simply becomes more compressed, and higher magnification factors, where a desired section is cropped from the image center and corrected without compression (or with less compression, according to the desired magnification), may both be realized. Any suitable interpolation method can be used, e.g., bilinear, spline, edge-sense, bicubic spline, etc. where further processing may be performed on the image, e.g., denoising or compression,

In this example, interpolation is performed prior to output. In some embodiments, interpolation could be performed after the read operation is complete and based on the entire image.

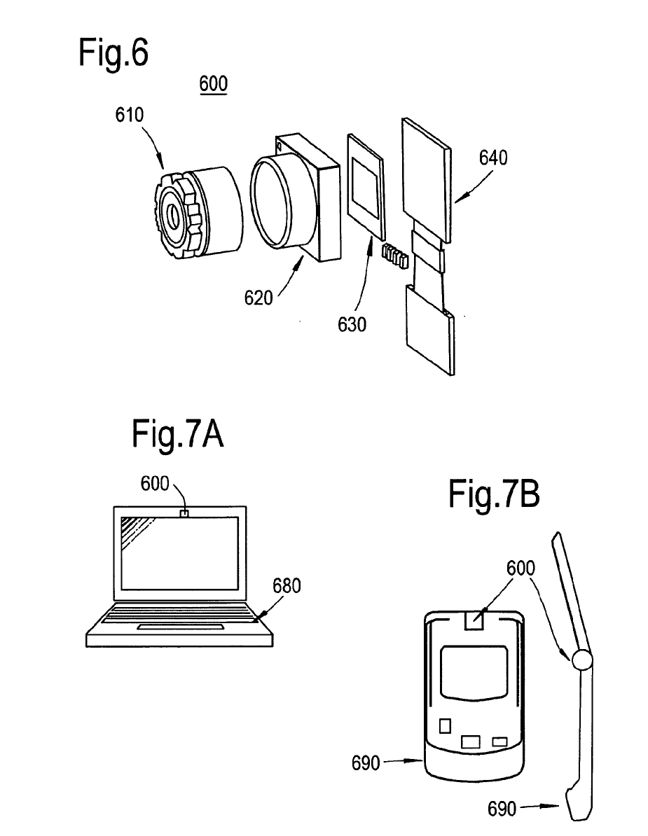

FIG. 6 illustrates an exploded view of a digital camera 600 in which an optical zoom system in accordance with embodiments may be employed. As seen therein, the digital camera 600 may include a lens system 610 to be secured to a lens holder 620, which, in turn, may be secured to a sensor 630. Finally, the entire assembly may be secured to electronics 640.

FIG. 7A illustrates a perspective view of a computer 680 having the digital camera 600 integrated therein. FIG. 7B illustrates a front and side view of a mobile telephone 690 having the digital camera 600 integrated therein. Of course, the digital camera 600 may be integrated at other locations than those shown.

More generally, a sensing device configured in accordance with the present subject matter can be incorporated into any suitable computing device, including but not limited to a mobile device/telephone, personal digital assistant, desktop, laptop, tablet, or other computer, a kiosk, etc. As another example, the sensing device can be included in any other apparatus or scenario in which a camera is used, including, but not limited to, machinery (e.g., automobiles, etc.) security systems, and the like.

Thus, in accordance with embodiments, an optical zoom may be realized using a fixed-zoom lens combined with post processing for distortion correction. A number of pixels used in the detector may be increased beyond a nominal resolution desired to support zoom capability.

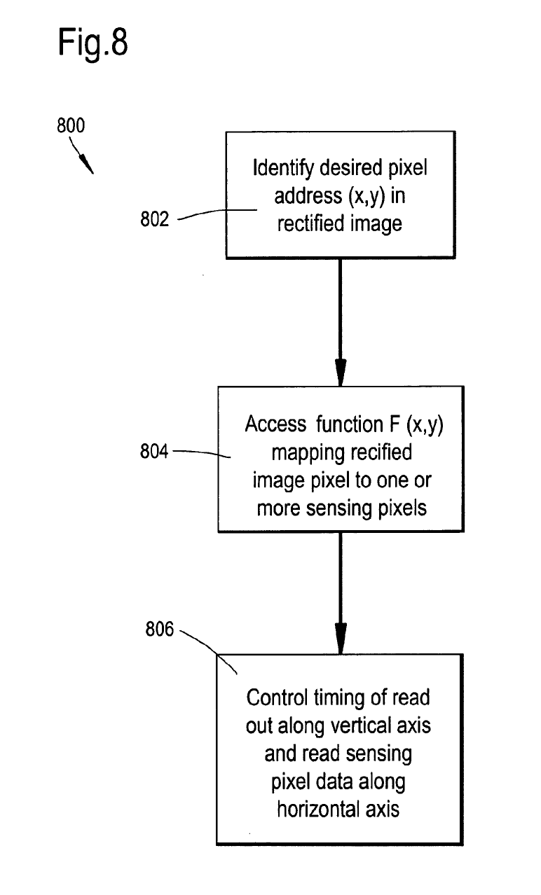

FIG. 8 illustrates an exemplary method 800 of reading an image sensor along a trajectory that corresponds to a distortion in the image as sensed. For example, the image sensor may be used to obtain a distorted image produced by optics configured in accordance with the teachings above or other optics that produce a known distortion. Method 800 may be carried out by a processor that provides one or more addresses to a sensor or may be carried out by logic or a processor associated with the sensor itself.

Block 802 represents identifying the desired pixel address in the rectified image. For example, an address or range of addresses may be identified, such as a request for a given row of pixels of the rectified image. As another example, a “read” command may be provided, which indicates that all pixels of a rectified image should be output in order. At block 804, a function F(x,y) mapping the rectified image pixel(s) to one or more sensing pixels is accessed or evaluated. F(x,y) may further include an input variable for a desired magnification so that an appropriate trajectory can be followed.

For example, a table may correlate rectified image pixel addresses to sensing pixel addresses based on row, column, and magnification factor. As another example, the logic or processor may access and evaluate an expression of F(x,y) to calculate the sensing pixel address or addresses for each desired pixel in the rectified image. As a further example, the sensor logic may feature appropriately-configured components (e.g., logic gates, etc.) to selectively read pixels along desired trajectories.

At block 806, appropriately-timed signals are sent to the sensor. In this example, the vertical access (row select) is timed to select the appropriate row(s) of sensing pixels while pixels are read along the horizontal axis (column select).

Thus, the sensor may be operated with a “trajectory rolling shutter” that starts from the location on the sensor corresponding to the first of the desired pixels and along the curve corresponding to the distortion. For example, the shutter may move near the vertical midpoint on the left side of the array up towards the top and then back towards the vertical midpoint on the right side of the array when a circular distortion is considered.

The period between the resetting of the pixel curves to the subsequent reading of the curve is defined as the integration time, T. This time is the controlled exposure time of the digital camera.

The exposure begins simultaneously for all pixels of the image sensor for a predetermined integration time, T. The frame time is the time required to read a single frame and it depends on the data read-out rate. For single rolling shutter pointers and single read-out pointers, the integration time, T, might be shorter than the frame time. In some embodiments, each particular curve, k, is accessed once by the shutter pointer and the read-out pointer during the frame time. Therefore, using a trajectory rolling shutter enables use of an identical desired integration time, T, for each pixel. A plurality of arcs can be retrieved from the sensor and the sensed pixel values used to determine pixel values for rows of the rectified image. As noted above, different arcs may be followed for different magnification levels, and each row of pixels in the rectified image may be determined from one or more arcs of sensed pixels.

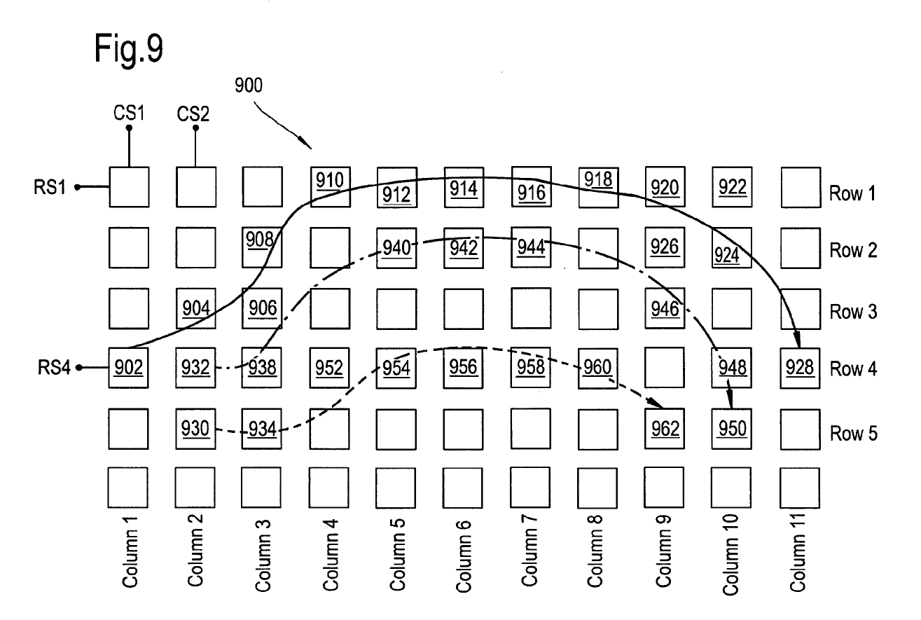

FIG. 9 illustrates an example of a plurality of pixels 900 arranged into rows 1-5 and columns 1-11. In the example of FIG. 9, a given row is selected using an address line (such as row select line RS1) and then individual pixels are read using column select lines (such as column select lines CS1, CS2), although a column could be selected and then individual pixels read by rows. FIG. 9 illustrates three exemplary trajectories by the solid line, dot-dashed line, and dashed line, respectively.

Pixel values used to produce a given row in the rectified image may be spread across pixels of a number of rows in the image as detected using the sensor. Additionally, pixel values that are in the same row in the rectified image may depend on pixels spread across non-overlapping rows in the distorted image as sensed.

For example, the solid line generally illustrates an example of a trajectory that can include pixels 902, 904, 906, 908, 910, 912, 914, 916, 918, 920, 922, 924, 926, and 928 that will be used to determine the upper row of pixels in a rectified image. The solid arrow and other arrows illustrating trajectories in this example are simplified for ease of illustration—for instance, the trajectories as illustrated in FIG. 9 cross some pixels that are included in the lists above and below while other pixels included in the list above are not crossed by the arrow. As noted above, the actual pixels of the rectified image may be determined by interpolating neighborhoods of pixels in the sensed image, and so the particular “width” of a trajectory can vary.

In any event, the pixels of this example span fall in rows 3-4 on the left side of the array, then fall in rows 2-3 and then 1-2 moving towards the (horizontal) center of the array, and then are again found in rows 2-3, and then row 4 as the trajectory moves to the right side of the array.

If the pixels illustrated in FIG. 9 were to be read in order (i.e., top-to-bottom) the imaging device would require sufficient frame buffer memory to capture all of rows 1-4 in order to obtain the first row of the rectified image. In practice, the distortion may cause pixels of a given row in a rectified image to span many more rows. For instance, in order to obtain pixels used to generate the initial row of a rectified image, a conventional assembly may require frame buffer memory equal to about 35% of the total lines of the sensor.

However, by reading along the trajectories, the required memory can be reduced—for example, the device need only include sufficient frame buffer memory to hold the pixels used to determine pixel values for a row of interest in the rectified image. For example, if a square of three pixels is interpolated for each single pixel in the rectified image, then three buffer lines can be used.

The dot-dashed line represents a trajectory of sensing pixels used to obtain a second row of pixels in the rectified image that is closer to the center. In this example, pixels 932, 938, 906, 940, 942, 944, 946, 948, and 950 are used. Note that pixel 906 is included for use in determining the second row of the rectified image as well as the first.

For some distortions, pixels from a row located towards the middle of the rectified image may be spread across fewer rows of the distorted image than pixels from a row located near one of the edges of the rectified image. For instance, the dashed line represents a trajectory of sensing pixels used to obtain a third row of pixels in the rectified image that is closer to the center of the image than the second row. In this example, pixels 930, 934, 952, 954, 956, 958, 960, and 962 are all used. Again, some of the same sensed pixels used for the second row factor in to determining pixel values for the third row of the rectified image. The third trajectory is “flatter” and spans only two rows in this example since it is closer to the center of the image (and the distortion is centered in this example).

A correlation process can be applied to the respective curves for each pixel, (u,v) with its nearest neighbors, from the subsequent row and the nearest neighbors from subsequent column. Using a F(x,y) map for example, a number of pixels to be shifted on two dimensional system it is applied on the respective curves of the frame. This process is repeated over all pixels, curve by curve, for each curve of the frame.

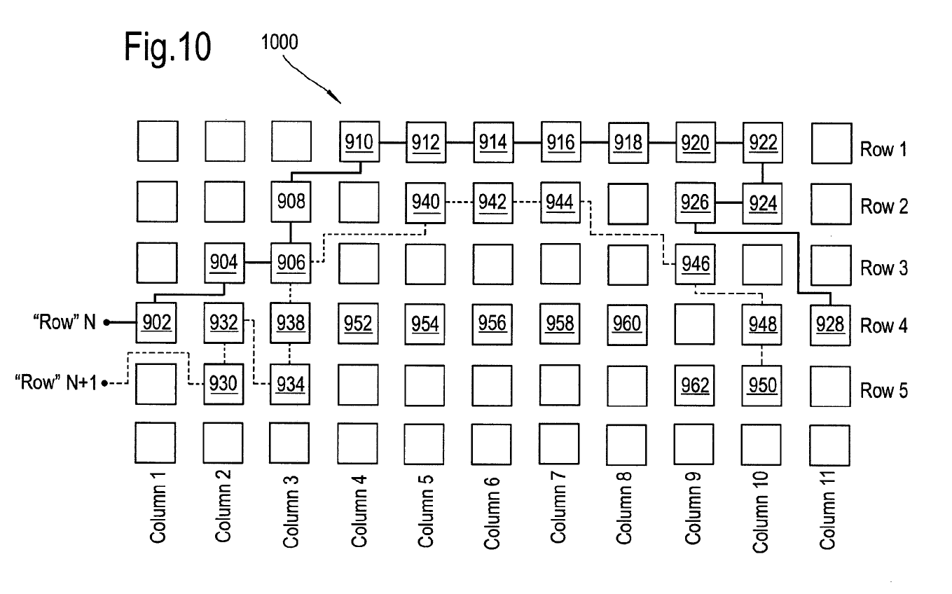

FIG. 10 illustrates another way to transform information from a curvature to a straight line. In this embodiment, some or all of the transformation can be realized on the sensor design level so that the affiliation of the pixels to the clock lines that grant read-out authorization (vertical axis), and to the reading of information from the pixels themselves (horizontal axis), will take place in the sensor itself according to the planned curvature. In order to accommodate corrections and slight modifications of the lens, this method can be rendered more flexible by transforming the information along several consecutive curvatures into buffers. In such a case, slight modifications in the reading trajectory may be decided upon according to the first method.

In other words, addresses are not ordered according to row and column. Instead, as shown in FIG. 10 at “Row” N and “Row” N+1, multiple pixels from technically different rows are associated with one another along the trajectories (with Row in quotation marks since the rows are actually trajectories). Instead, one or more arcs can be selected and then individual pixels along the arc(s) read in order. Two trajectories are shown in this example using the solid line and a dotted line. In this example, the sensor logic is configured so that the clock for read out is not linked to the column order. Instead, the pixels are linked to their order in corresponding trajectories. This example also illustrates that for certain trajectories the same pixel may be read twice due to the effects of the distortion—for instance, pixel 906 is the third pixel read along “Row” N but is the fifth pixel read along “Row” N+1.

Flexibility may be increased for this method also by enabling reading the addresses of several curves, thus avoiding the use of buffers. As was noted above, a trajectory may consist of a single line of pixels or multiple lines of pixels and/or a number of arcs may be used to output a single row of pixels. The underlying logic for reading the pixel trajectories may be included directly in the sensor itself or as a module that translates read requests into appropriate addressing signals to a conventional sensor. The logic may be configured to accommodate the use of different read trajectories for different magnification levels.

Another problem that arises with the transformation of information from a curvature to a straight line stems from the fact that the closer curves are to the central vertical axis, the denser they are. This density leads to the overlapping of several lines on a certain pixel (see, for example, pixel 906 that is included along both trajectories in FIG. 10). Thus, when reading a consecutive curvature, it often happens that a pixel is read whose information has already been retrieved and which has been reset as part of the reading process whereby information that has been read is reset. To prevent reading of irrelevant information after resetting, a command can be introduced into the read-out design that copies information from the previous read-out of pixels that contain/have overlapping curves.

Transforming information from a curvature to a straight line yields rows of different length. The row that represents the horizontal line in the center of the sensor is the shortest and the farther the curve is from the center, the longer it becomes after rectification. To create uniformity in data processing that requires rows of identical length, the missing information in the short rows can be completed using zeros so that they may later be ignored. Alternately, the expected number of pixels containing true information in each row can be predetermined.

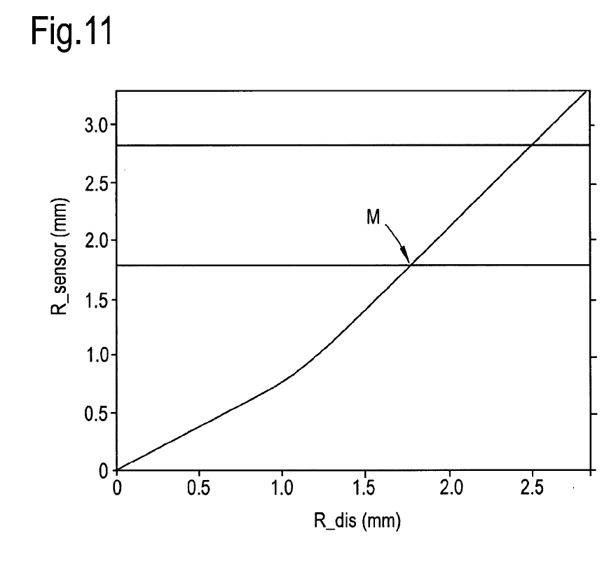

FIG. 11 illustrates an example of a function mapping pixels of a rectified and distorted image. In the illustration, M represents one half the height of the sensor and W represents one half the width of the sensor. R_sensor is the standard location of the pixels in the rectified image, while R_dis represents the new location of those pixels due to the distortion. FIG. 11 relates R_sensor to R_dis. In this example, the distortion is circular, symmetric, and centered on the sensor, although the techniques discussed herein could apply to distortions that are asymmetric or otherwise vary across the sensed area as well.

FIG. 12 shows an example of how an array 1210 of sensor pixels can be mapped to an array 1212 of output image pixels using a nearest-neighbor integer mapping. Generally, an addressing method can be used in some embodiments in order to account for the lens distortion and desired zoom factor as explained above. For instance, pixels in an output image can have (x,y) coordinates that correspond to physical sensor pixels whose coordinates are (u,v) with the relationship expressed as:

$$\begin{matrix}u = x \frac{f ( r )}{r} & ( 5 ) \\ v = y \frac{f ( r )}{r} & ( 6 )\end{matrix}$$

where r=\sqrt{x²+y²} is the radius from the optical axis and f is a function representing the radial distortion introduced by the lens. Taking lens decentering (Δx,Δy) into account, this relationship becomes:

$$\begin{matrix}u = x \frac{f ( r )}{r} + Δ x & ( 7 ) \\ v = y \frac{f ( r )}{r} + Δ y & ( 8 )\end{matrix}$$

Integer output coordinates (x,y) may oftentimes be transformed to fractional sensor coordinates (u,v). Thus, some sort of interpolation method can be used and, in order to achieve sufficient image quality, the interpolation should be sufficiently advanced. For instance, if image data is in Bayer format, then the interpolation procedure should be Bayer adapted, such as in terms of local demosaicing. However, for ease of explanation, embodiments will be explained below using a simplified case of nearest neighbor (NN) interpolation. Specifically, the value of each output pixel (x,y) in FIG. 12 is set to be the sensor value at ([u], [v]), with the brackets [ ] denoting the interpolation that yields the closest integer value.

To summarize the nearest-neighbor case, an output image Iₒᵤₜ can be expressed as a function of an input image Iᵢₙ, with the input image Iᵢₙ resulting from imaging light onto an array (u,v) of pixels.

Iₒᵤₜ(x,y)=Iᵢₙ([u],[v]) (9)

FIG. 13 shows an example of horizontal lines 1310 as distorted by a lens, with the distorted lines shown at 1312. The illustration of FIG. 13 also shows how one horizontal line 1311 is subjected to maximum vertical distortion as shown at 1313. As noted above with respect to FIGS. 9-10, significant vertical distortion can occur in some embodiments depending on the optics used to image light onto the sensor.

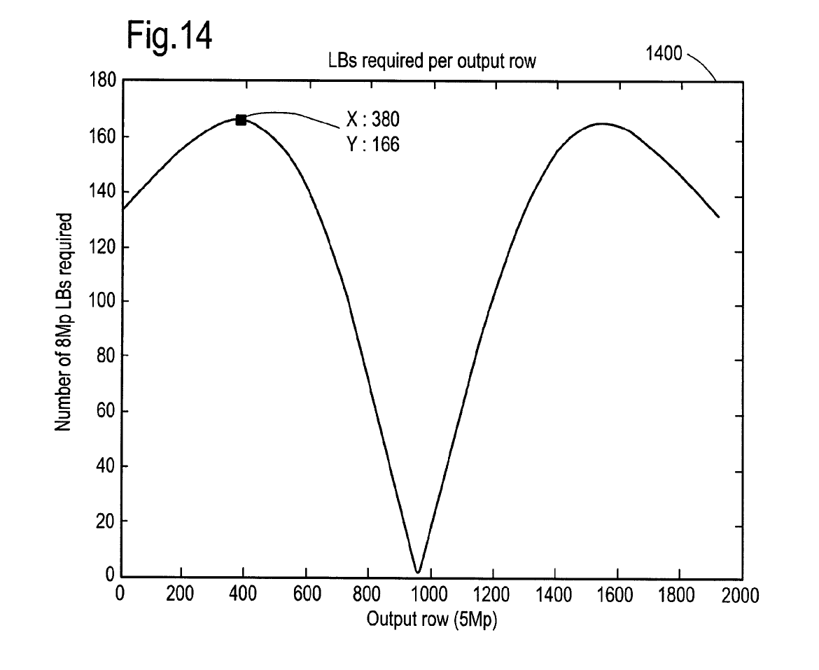

FIG. 14 is a chart 1400 showing example values of the number of 8 megapixel line buffers (on the y-axis of chart 1400) required to read various single rows of an output image directly (with row number on the x-axis), taking into account vertical distortion that spreads pixel values corresponding to that row across multiple rows of sensor pixels. In this case, a normal 8 Mp (3264×2448) sensor is used along with a lens introducing ×1.3 distortion, with the intended output image being 5 Mp (2560×1920) in size. As can be seen, simply following the trajectories, i.e., the F(x,y) map, can result in a very large number (˜166) of line buffers in some embodiments, since sufficient line buffers would need to be included in order to accommodate the maximum-distorted rows.

Some embodiments may in fact read the pixels of the sensor using a mapping based on the distortion function and a suitably-configured buffer memory. However, additional embodiments may overcome the memory requirements by wiring pixels of the sensor along trajectories based on the distortion function.

As noted briefly above with respect to FIG. 10, such a sensor arrangement results in a sensor that no longer provides image information in the usual form of rows and columns—i.e., the Bayer image is disrupted. Additionally, certain pixels may need to be read “twice,” while other pixels may not lie along the trajectories, resulting in the potential for “holes” in the image. As explained below, embodiments can use sufficient logic to cover all sensor pixels and, at the same time, read the sensor pixels in a way that is compatible with the distortion.

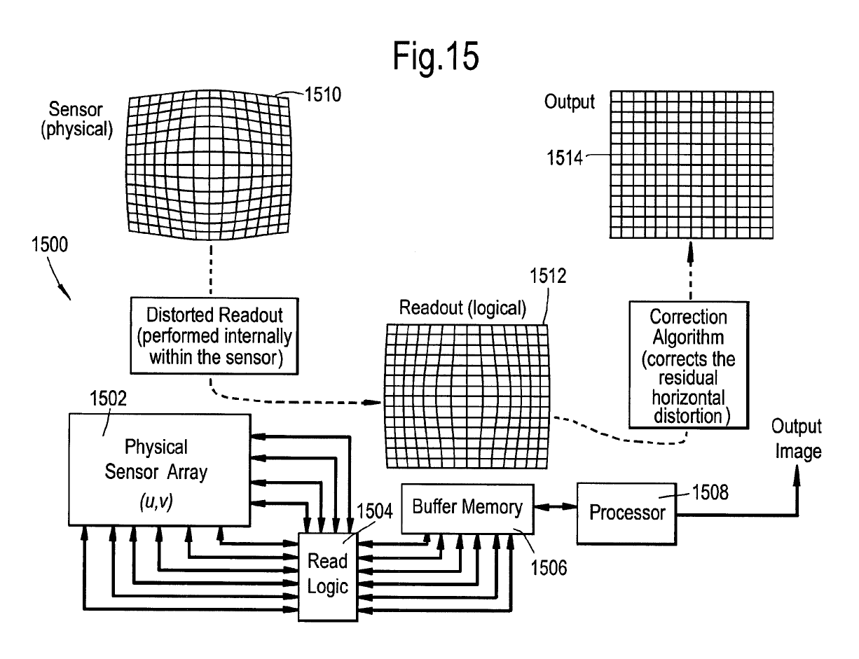

FIG. 15 is a diagram illustrating an example of a sensing device 1500, along with a multi-step readout process that uses a distorted readout (“virtual sensor” or “logical sensor”) and a correction algorithm to generate output pixels. As shown at 1502, the sensing device comprises an array of sensor pixels interfaced to read logic 1504 and a buffer 1506. A processor 1508 includes program components in memory (not shown) that configure the processor to provide a read command to the sensor logic and to read pixel values from buffer 1506.

Read logic 1504 provides connections between sensor pixels in the array and corresponding locations in the buffer 1506 so that an image can be stored in the buffer based on the values of the sensor pixels. The read logic could be configured to simply sample pixel values at corresponding sensor array addresses in response to read requests generated by processor 1508. In such a case, the corresponding addresses in an output image could be determined by the processor according to the distortion function.

However, in some embodiments, the read logic 1504 is configured to sample one or more pixel values from the array of sensor pixels in response to a read command and provide pixels to the buffer based on a distortion function. Due to the distortion function, the corresponding pixel address in the sensor array will generally have a different column address, a different row address, or both a different column address and a different row address than the corresponding pixel address in the image as stored in the buffer. Particularly, read logic 1504 can be configured to read the pixels along a plurality of trajectories corresponding to the distortion function. In some embodiments, different sets of trajectories correspond to different zoom factors—i.e., different trajectories may be used when different zoom levels are desired as mentioned previously.

As shown at 1510, the sensor pixel array features both horizontal and vertical distortion. Read logic 1504 can be configured to read/sample the pixel values in the array and to provide a logical/virtual readout array shown at 1512. Logical readout 1512 can correspond to a “virtual sensor” or “logical sensor” that itself retains some distortion, namely horizontal distortion. For instance, during readout, the logical rows can be stored in buffer 1506, with processor 1508 configured to read the logical row values and to carry out a correction algorithm to correct the residual horizontal distortion (and other processing, as needed) in order to yield an output image 1514 as shown in FIG. 15.

Due to the trajectories used by read logic 1504, the vertical distortion is removed or substantially removed even in the logical/virtual readout array. Additionally, the read logic can be configured so that, for each trajectory, a corresponding logical readout row in the logical readout is provided, the logical rows having the same number of columns as one another, with each column corresponding to one of the columns of the sensor array.

Use of read logic 1504 to read along trajectories can advantageously reduce memory requirements and preserve the sensor column arrangement. For instance, although an entire virtual/logical readout image 1512 is shown in FIG. 15 for purposes of explanation, in practice only a few rows of a virtual/logical readout image may need to be stored in memory in order to assemble a row of the output image.

Read logic 1504 can be implemented in any suitable manner, and the particular implementation of read logic 1504 should be within the abilities of a skilled artisan after review of this disclosure. For example, the various pixels of the sensor array can be conditionally linked to buffer lines using suitably-arranged logic gates, for example constructed using CMOS transistors, to provide selectably-enabled paths depending upon which trajectories are to be sampled during a given time interval. For example, the logic gates can be designed so that different sets of trajectory paths associated with different zoom levels are selected. When a particular zoom level is input, a series of corresponding trajectories can be used to sample the physical array, cycling through all pixels along the trajectory, then to the next trajectory, until sampling is complete.

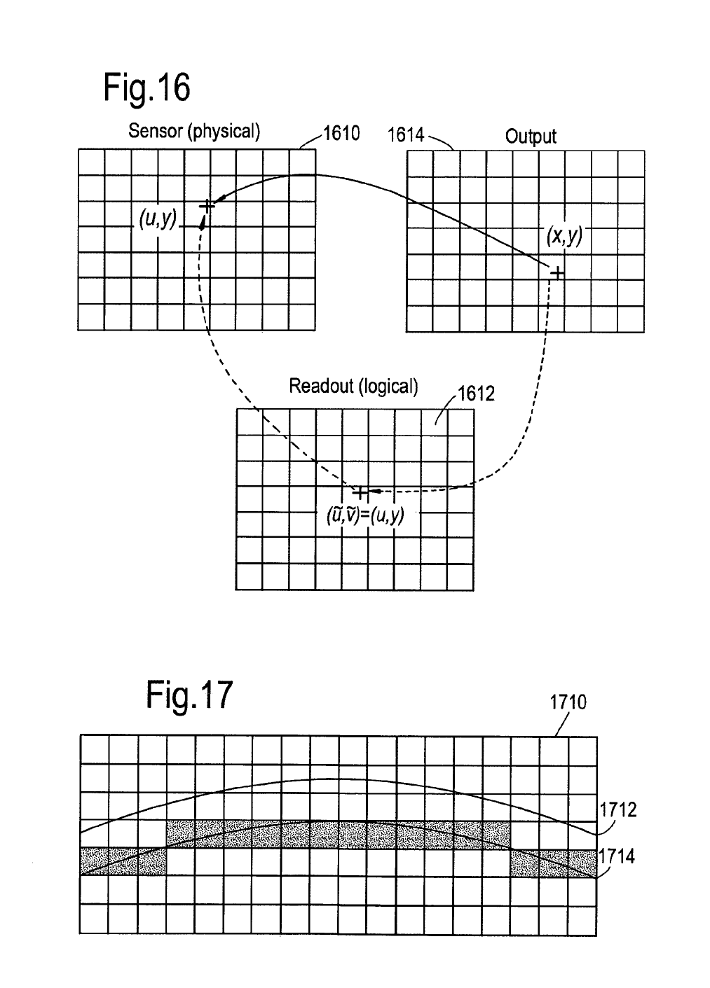

FIG. 16 is a diagram showing relationships between values in a physical sensor array 1610, a virtual/logical readout array 1612, and an output image 1614. As noted previously, the basic relationship between the sensor pixel array and output image array can be expressed as

Iₒᵤₜ(x,y)=Iᵢₙ(u,v) (10)

The basic relationship is shown in FIG. 16 as the non-dashed line between the pixel in array 1610 and the pixel in array 1614. However, the readout order coordinate in the virtual/logical array (ũ, \tilde{v}) can be defined by

$$\tilde{u} = u = x \frac{f ( r )}{r} + Δ x \\ \tilde{v} = y \qquad ( 11 )$$

Thus, the image in the reordered sensor outputs (i.e. the virtual or logical sensor array 1612) can be defined by

I_{R/O}=(ũ,\tilde{v})=Iᵢₙ(u,v) (12)

and

Iₒᵤₜ(x,y)=Iᵢₙ(u,v)=I_{R/O}(u,y)(13)

Rather than using a standard algorithm that maps a pixel value at (u,v) to an output image position (x,y), the algorithm can determine a virtual/logical sensor pixel value at (u,v) as corresponding to the value at an output position (x,y) as shown by the dashed line between the pixel in output image array 1614 and readout image array 1612

In order to implement the solution outlined above, discrete coordinates are used based on considerations implied from the continuous readout case. Namely, horizontal output lines will appear as distorted curves on the sensor. For instance, as noted by the expression below, the line y₀ in the output image will appear as a curve whose coordinates on the sensor array are:

$$u = x \frac{f ( r )}{r} + Δ x \\ v = {y}_{0} \frac{f ( r )}{r} + Δ y \qquad ( 14 )$$

In light of this geometry, the read logic can be configured so that each virtual/logical sensor row comprises one pixel from each physical sensor column. Particularly, as indicated by the shaded pixels in FIG. 17, each trajectory 1712 and 1714 used in sampling pixel values of physical sensor array 1700 features one pixel for each column of physical sensor array 1700. This can provide advantages such as (1) minimizing the amount of memory for line buffers, (2) an arrangement in which each sensor pixel is connected for readout, (3) no pixel is connected more than once, and (4) the connection method can be described by a function and simple logic, which eases implementation.

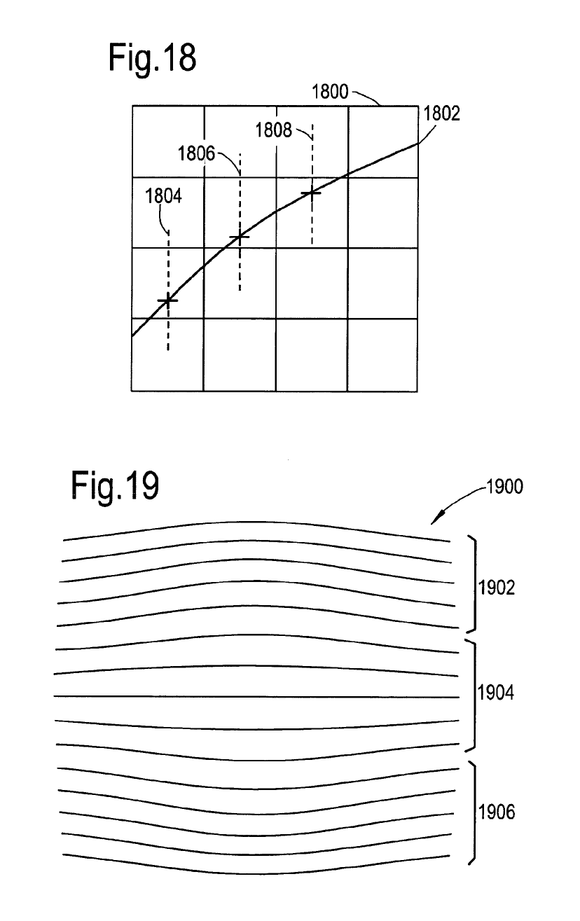

FIG. 18 illustrates an example of how a physical sensor pixel can be associated with a virtual/logical sensor pixel based on a trajectory for use in configuring the connection logic. In this example, an array 1800 is traversed by a distortion trajectory illustrated as a curve 1802. Starting from the first column on the left, each pixel of the array can be scanned from top to bottom along an imaginary line (1804, 1806, 1808) through the center of each column. Whenever curve 1802 is intersected, the pixel in which the intersection occurs is connected using suitable logic so that the pixel in which the intersection occurs is associated with whichever pixel is the site of intersection with the same curve in the next column, and so on. The result will be that each curve will be associated with a row of pixels equal to the number of columns of the physical sensor. If two curves pass through a pixel, the pixel will be associated with the top most curve, since the intersection analysis proceeds from top to bottom.

FIG. 19 illustrates how, in some embodiments, trajectory density can vary across a distorted image. As shown at 1900, the distortion curves are not uniformly distributed. Particularly, the curves are denser at 1902 and 1906 than at 1904. The example readout order construction noted above does not itself account for the varying density.

Either or both the following issues may result: (1) consecutive curves may skip pixels—e.g., in areas of low line density where magnification is greatest, certain pixels may not be associated with a curve; and/or (2) two consecutive curves may intersect the same pixel—e.g., in areas of high line density due to low or negative magnification. Conventional pixels are discharged when read—i.e., a pixel can only be read once. Even if a pixel were capable of being read multiple times, double-readouts may unnecessarily delay the imaging process.

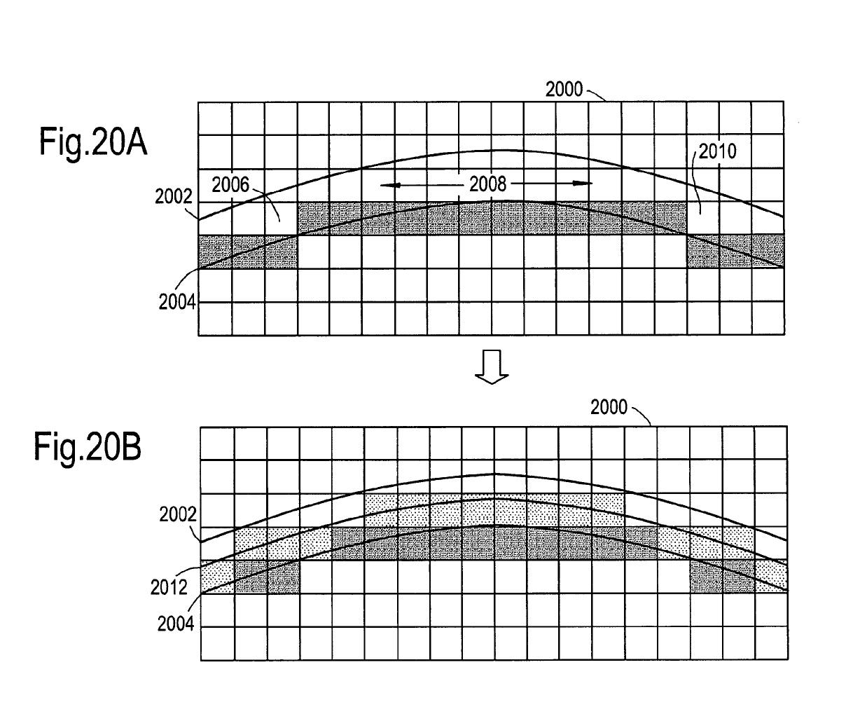

FIGS. 20A-20B illustrate how, in some embodiments, additional trajectories can be used to avoid the problem of skipped pixels due to trajectory density. FIG. 20A shows an array 2000 of physical sensor pixels along with two trajectories 2002 and 2004. As indicated by the shading, each trajectory is associated with a single pixel from each column. However, due to the low density, several areas 2006, 2008, and 2010 feature one or more pixels that are not read.

FIG. 20B illustrates the use of an additional curve 2012 to alleviate the skipped pixels issue. Based on the distortion map, additional curves can be included so that the distribution is more uniform—put another way, the number of rows in the virtual/logical readout array can be increased so that a uniform readout occurs. The minimal number of virtual rows can be calculated using optimization, i.e., the maximal effective magnification by the lens. As an example, for a lens with a maximal magnification of 1.3×, the distortion curve density can be increased to 130% the original density, with a resulting virtual/logical readout array with a height 1.3 times larger than the physical sensor.

As shown in FIG. 20B, the same area sampled using two rows of the virtual/logical array can be replaced with three rows. However, in addressing skipped pixels, the problem of double-readouts may be increased. This issue, however, can be solved by using “dummy” pixels.

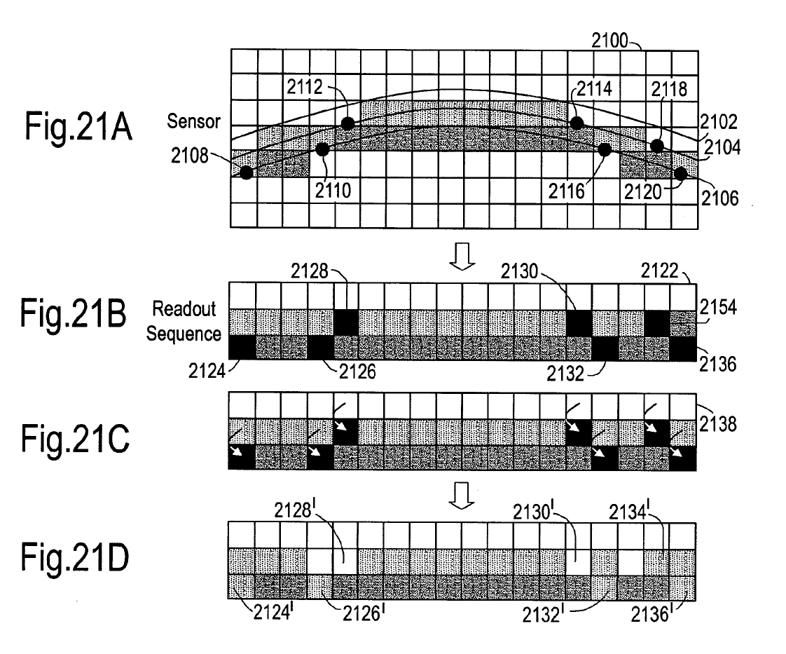

FIGS. 21A-21D illustrate how dummy pixels can be used to avoid reading a physical sensor pixel twice due to intersection with multiple curves. FIG. 21A shows curves 2102, 2104, and 2106 traversing array 2100. Double-readout situations are shown at 2108, 2110, 2112, 2114, 2116, 2118, and 2120. Generally speaking, the value of a pixel intersected by several consecutive curves should be assigned to several consecutive rows in the virtual/logical readout array. However, as noted above, in current sensor designs pixel values may only be physically determined once.

In some embodiments, to address this issue each physical pixel is sampled only once in conjunction with the first curve that intersects the pixel in chronological order. For subsequent curves, a dummy pixel can be output in the virtual/logical array to serve as a placeholder. This can be achieved, for example, by using logic to connect the sensor pixel to be sampled as part of the first curve that intersects the pixel, with the pixel value routed to the corresponding row of the logical/virtual readout array with other pixels of the curve. However, for other curves that intersect the same pixel, the output logic for the corresponding rows can be wired to ground or voltage source (i.e., logical 0 or 1) to provide a placeholder for the pixel in the other row(s) as stored in memory.

The end result is shown in array 2122, which represents three rows of the logical/virtual pixel array corresponding to curves 2102, 2104, and 2106. As can be seen, dummy pixels 2124, 2126, 2128, 2130, 2132, 2134, and 2136 have been provided as indicated by the black shading. For instance, in the case of dummy pixel 2124, the actual pixel value was sampled for the row above, and so on. The dummy pixels can be resolved to their desired readout value based on the value of the non-dummy pixel above the dummy pixel in the same column as indicated by the arrows in FIG. 21C. This is shown at 21D, where pixels 2124′, 2126′, 2128′, 2130′, 2132′, 2134′, and 2136′ now have associated values.

The resulting virtual/logical readout array features a number of columns equal to the number of columns in the array of pixels in the physical sensor, with a row corresponding to each trajectory across the sensor. Given the readout order, a processor accessing the sensor should understand the pixel stream coming from the sensor without necessarily relying on information from the sensor interface. The processor may be a processor block within the sensor or a separate processor accessing the sensor via read logic and the buffer.

From the processor's point of view, the sensor can be viewed as a set of physical memory reorganized to be more efficiently accessed via the logical interface (i.e., the readout that results in the virtual/logical array). The addressing algorithm used to generate an output image can be developed by discretizing the overall approach.

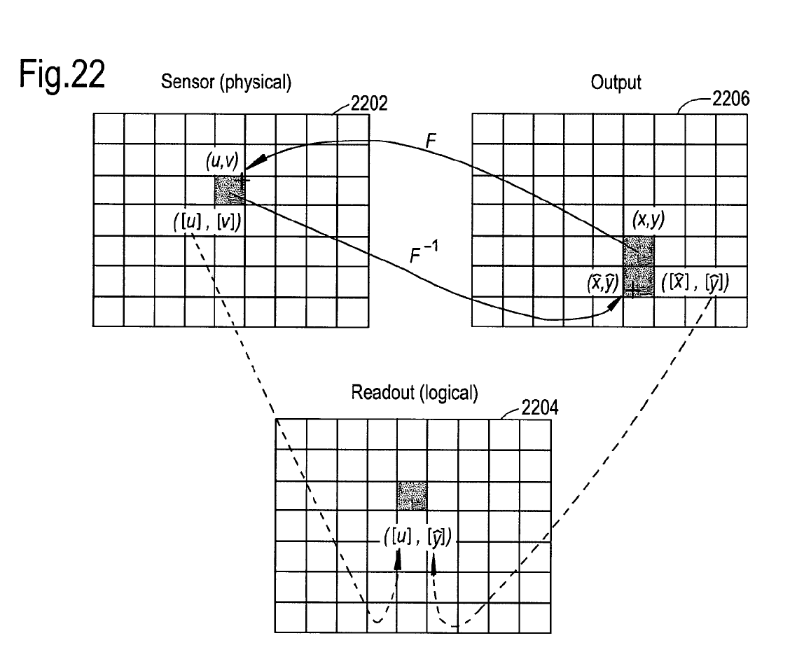

FIG. 22 illustrates relationships between output pixels, virtual/logical sensor pixels, and physical sensor pixels. Specifically, FIG. 22 depicts an array 2202 of physical sensor pixel values, the virtual/logical readout array 2204 provided by read logic of the sensor, and the desired array of pixels 2206 of an output image.

As noted previously, the output and sensor images are related by

Iₒᵤₜ(x,y)=Iᵢₙ(u,v) (15)

The relationship between output image pixel coordinates (x,y) and sensor coordinates (u,v) conveniently expressed as

(u,v)=F(x,y) (16)

Additionally, the virtual/logical readout array can be represented in the expression

Iₒᵤₜ(x,y)=Iᵢₙ(u,v)=I_{R/O}(u,y) (17)

where the corresponding readout coordinates are given by taking the horizontal sensor coordinate (u) and the output vertical coordinate (y).

For the discrete case, first define an intermediate output coordinate using an inverse mapping between the output image and the physical sensor image:

(\hat{x},ŷ)=F⁻¹([u],[v]) (18)

The output coordinates (\hat{x},\hat{v}) are obtained by applying the inverse mapping F⁻¹ to the nearest neighbor pixel ([u],[v]) of the sensor coordinates (u,v) obtained in Equation 16.

Thus, the relationship between the output image 2206 and virtual/logical readout image 2204 can be stated as

Iₒᵤₜ(x,y)=Iᵢₙ(u,v)=I_{R/O}([u],[ŷ]) (19)

where

(u,v)=F(x,y)

(\hat{x},\hat{v})=F⁻¹([u],[v]) (20)

The relationship is also shown in FIG. 22. Accordingly, generating an output image based on the read pixels can comprise accessing pixels in the logical output rows according to a function relating output image pixel coordinates to logical image pixel coordinates.

In some embodiments, a sensor with a distorted readout configured in accordance with the teachings above can allow for correction of a distorted image using as few as three line buffers. The distorted readout can compensate for the entire vertical distortion up to deviations of plus or minus 1 vertical pixels due to the discretization. In practice, more line buffers may be used in order to utilize a work window. For example, for an N×N work window, 3+N line buffers would be the minimum number.

As used herein, the term “and/or” includes any and all combinations of one or more of the associated listed items. Further, although terms such as “first,” “second,” “third,” etc., may be used herein to describe various elements, components, regions, layers and/or sections, these elements, components, regions, layers and/or sections should not be limited by these terms. These terms are only used to distinguish one element, component, region, layer and/or section from another. Thus, a first element, component, region, layer and/or section could be termed a second element, component, region, layer and/or section without departing from the teachings of the embodiments described herein.

Spatially relative terms, such as “beneath,” “below,” “lower,” “above,” “upper,” etc., may be used herein for ease of description to describe the relationship of one element or feature to another element(s) or feature(s), as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

As used herein, the singular forms “a,” “an” and “the” are intended to include the plural forms as well, unless the context clearly indicates otherwise. It will be further understood that the terms “comprises,” “comprising,” “includes,” and “including” specify the presence of stated features, integers, steps, operations, elements, components, etc., but do not preclude the presence or addition thereto of one or more other features, integers, steps, operations, elements, components, groups, etc.

Embodiments of the present invention have been disclosed herein and, although specific terms are employed, they are used and are to be interpreted in a generic and descriptive sense only and not for purpose of limitation. While embodiments of the present invention have been described relative to a hardware implementation, the processing of present invention may be implemented in software, e.g., by an article of manufacture having a machine-accessible medium including data that, when accessed by a machine, cause the machine to access sensor pixels and otherwise undistort the data. For example, a computer program product may feature a computer-readable medium (e.g., a memory, disk, etc.) embodying program instructions that configure a processor to access a sensor and read pixels according to a function mapping output image pixel addresses to sensor addresses and/or according to a function mapping output image pixel addresses to pixel addresses in a logical/virtual readout image.

Further, while the above discussion has assumed the pixels have an equal pitch across the detector, some of all of the compression may be realized by altering the pitch across the detector. Accordingly, it will be understood by those of ordinary skill in the art that various changes in form and details may be made without departing from the spirit and scope of the present invention.

1. An image capture device, comprising:
an optical system configured to image an object onto a detector, the optical system introducing a distortion into the image; and
a processor configured to generate an output image of the object, wherein the output image is generated using pixel values read from the detector based on a trajectory corresponding to the distortion of the image.

2. The image capture device set forth in claim 1, wherein the processor is configured to read pixel values sampled along rows and columns of the detector and to use a plurality of trajectories corresponding to the distortion of the image and a desired magnification level to generate the output image.

3. The image capture device set forth in claim 1, wherein the trajectory is determined from a distortion function associated with the optical system.

4. The image capture device set forth in claim 1, wherein the trajectory is determined from a table mapping sensor pixel addresses to image pixel addresses.

5. The image capture device set forth in claim 1, wherein the detector is configured to read pixels along the trajectory in response to a read command.

6. The image capture device set forth in claim 5, wherein the detector comprises logic to read pixels along a plurality of trajectories and to provide a plurality of logical readout rows, each logical readout row corresponding to a trajectory and having a single pixel for each column of the detector, and wherein the processor is configured to use pixel values in the plurality of logical readout rows to generate the output image according to a function relating output image pixel addresses to logical readout image pixel addresses.

7. The image capture device set forth in claim 1 incorporated into a mobile telephone or a computing device.

8. A sensing device, comprising:
an array of sensor pixels; and
read logic, the read logic configured to provide one or more pixel values from the array of sensor pixels to a buffer memory in response to a read command,
wherein the read logic comprises a plurality of connections, each connection connecting a pixel at an address in the array of sensor pixels to a location in the buffer memory, the location representing a corresponding pixel address in an image in the buffer memory, and
wherein the pixel's address in the array of sensor pixels comprises a different column address, a different row address, or both a different column address and a different row address than the corresponding pixel address in the image in the buffer memory.

9. The sensing device set forth in claim 8, wherein the read logic configures the sensing device to read a plurality of pixels from the array of sensor pixels along a trajectory, the trajectory corresponding to a distortion function of an optical system configured to image a field of view onto the array of sensor pixels.

10. The sensing device set forth in claim 9, wherein the trajectory further corresponds to a zoom factor.

11. The sensing device set forth in claim 8, wherein the read logic configures the sensing device to read a plurality of pixel values in the array of sensor pixels along a plurality of trajectories and to provide a logical readout row for each trajectory, each logical readout row having a single column corresponding to each column of the array of sensor pixels.

12. The sensing device set forth in claim 11, wherein the read logic configures the sensing device to read a plurality of pixel values in the array of sensor pixels according to a uniform distribution of trajectories, and wherein the read logic configures the sensing device to provide a dummy pixel value to a pixel in the logical readout row if the value of the corresponding pixel in the array of sensor pixels is provided to a pixel in the same column of an adjacent logical readout row.

13. The sensing device set forth in claim 8, incorporated into a mobile device or a computing system.

14. The sensing device set forth in claim 8, further comprising a processor configured to access the logical readout rows and generate the output image according to a function relating output image pixel addresses to logical readout image pixel addresses.

15. The sensing device set forth in claim 14, wherein the processor is further configured to use an N×N window to interpolate the logical readout rows, and wherein the number of logical readout rows is not greater than 3+N.

16. An imaging method, comprising:
imaging a distorted image onto an array of sensor pixels;
reading the sensor pixels according to the distortion of the image; and
generating an output image based on the read pixels, the output image substantially or completely free of distortion.

17. The imaging method set forth in claim 16, wherein reading the pixels according to the distortion of the image comprises using logic of a sensor to sample pixel values along a plurality of trajectory lines corresponding to the distortion and providing a plurality of logical output rows, wherein each logical output row comprises a single pixel value corresponding to each column of the array.

18. The imaging method set forth in claim 17, wherein at least two trajectory lines intersect the same pixel twice,
wherein the logic of the sensor is configured to provide a dummy pixel value during readout for one of the logical output rows in place of a value for the pixel that is intersected twice, and
wherein the logic of the sensor is further configured to replace the dummy pixel value with the value of a non-dummy pixel at the same column address and lying in another logical row.

19. The imaging method set forth in claim 18, wherein generating an output image based on the read pixels comprises accessing pixels in the logical output rows according to a function relating output image pixel coordinates to logical image pixel coordinates.

20. The imaging method set forth in claim 16, wherein reading the pixels according to the distortion function comprises using a processor to access pixel values sampled according to rows and columns, the processor configured to access the pixel values by using a mapping of output image pixel coordinates to sensor pixel coordinates.
